(19) United States
(12) Patent Application Publication
(10) Pub. No.: US 2025/0190927 A1
(43) Pub. Date: Jun. 12, 2025

(54) METHOD AND TERMINAL DEVICE

(71) Applicant: TOYOTA JIDOSHA KABUSHIKI KAISHA, Toyota-shi Aichi-ken (JP)

(72) Inventors: Yosuke KAMADA, Yokohama-shi Kanagawa-ken (JP); Satoshi KUME, Nagakute-shi Aichi-ken (JP); Satoru SAKUMA, Nagakute-shi Aichi-ken (JP); Takeshi TAKEMOTO, Nagoya-shi Aichi-ken (JP); Yuho KATO, Nagoya-shi Aichi-ken (JP); Shintaro MATSUTANI, Kariya-shi Aichi-ken (JP)

(73) Assignee: TOYOTA JIDOSHA KABUSHIKI KAISHA, Toyota-shi Aichi-ken (JP)

(21) Appl. No.: 18/938,797

(22) Filed: Nov. 6, 2024

(30) Foreign Application Priority Data
Dec. 12, 2023 (JP) 2023-209655

(51) Int. Cl. G06Q 10/0833; G06Q 30/0283; G06Q 30/0601

(52) U.S. Cl. CPC G06Q 10/0833; G06Q 30/0283; G06Q 30/0621; G06Q 30/0643

(57) ABSTRACT

A method to be executed by a terminal device includes: receiving option information indicating options from an information processing device via a communication unit; outputting the options via an output unit; receiving an input of one or more options selected by a user via an input unit; transmitting selection information indicating the one or more options to the information processing device via the communication unit; receiving, from the information processing device via the communication unit, delivery timing information indicating a delivery timing determined based on the one or more options indicated by the selection information; and outputting the delivery timing together with the one or more options via the output unit.

### CROSS-REFERENCE TO RELATED APPLICATION

This application claims priority to Japanese Patent Application No. 2023-209655 filed on Dec. 12, 2023, incorporated herein by reference in its entirety.

### BACKGROUND

### 1. Technical Field

The present disclosure relates to a method and a terminal device.

### 2. Description of Related Art

Hitherto, there is a technology for providing quotes for custom-made products. For example, Japanese Unexamined Patent Application Publication No. 2009-245446 (JP 2009-245446 A) discloses a system that uses a relational database to centrally manage data to be accessed by various departments when creating quotes for customers.

### SUMMARY

When a user selects options at the time of purchasing a vehicle, there is a possibility that the user cannot grasp the effect of the selected options on the delivery timing of the vehicle and cannot use the delivery timing for consideration about the purchase of the options. Thus, there is room for improvement in technology that assists users when purchasing vehicle options.

A method according to a first aspect of the present disclosure is a method to be executed by a terminal device including an input unit, an output unit, a communication unit, and a controller, the communication unit being configured to communicate with an information processing device configured to provide information on vehicle options, the method including: receiving, by the controller, option information from the information processing device via the communication unit, the option information indicating at least one of the vehicle options; outputting, by the controller, the at least one of the vehicle options via the output unit; receiving, by the controller, an input of one or more selected options selected by a user from the at least one of the vehicle options via the input unit;

transmitting, by the controller, selection information indicating the one or more selected options to the information processing device via the communication unit; receiving, by the controller from the information processing device via the communication unit, delivery timing information indicating at least one delivery timing determined based on the one or more selected options indicated by the selection information; and outputting, by the controller, the at least one delivery timing together with the one or more selected options via the output unit.

In the method according to the above aspect, the at least one of the vehicle options indicated by the option information may be a plurality of vehicle options, the selection information may include a plurality of selection sets each including a plurality of the selected options selected by the user from among the plurality of vehicle options, the delivery timing information may indicate a plurality of delivery timings, each of the delivery timings being determined for a corresponding one of the selection sets, and the method may further include outputting, by the controller, the delivery timings via the output unit.

The method according to the above aspect may further include outputting, by the controller, the delivery timings in order from an earliest delivery timing together with the selection sets via the output unit.

The method according to the above aspect may further include: receiving, by the controller from the information processing device via the communication unit, deletion candidate option information indicating a deletion candidate option that is expected to, when not selected, bring forward the delivery timing by a predetermined period or more among the one or more selected options indicated by the selection information; and outputting, by the controller, the deletion candidate option with highlight via the output unit.

A method according to a second aspect of the present disclosure is a method to be executed by a terminal device including an input unit, an output unit, a communication unit, and a controller, the communication unit being configured to communicate with an information processing device configured to provide a sales website for vehicle options. The method includes: receiving, by the controller, option information from the information processing device via the communication unit, the option information indicating at least one of the vehicle options; outputting, by the controller, the at least one of the vehicle options via the output unit; receiving, by the controller, an input of one or more selected options selected by a user from the at least one of the vehicle options via the input unit; transmitting, by the controller, selection information indicating the one or more selected options to the information processing device via the communication unit; receiving, by the controller from the information processing device via the communication unit, delivery timing information indicating at least one delivery timing determined based on the one or more selected options indicated by the selection information; and outputting, by the controller, the at least one delivery timing together with the one or more selected options via the output unit.

In the method according to the above aspect, the at least one of the vehicle options indicated by the option information may be a plurality of vehicle options, the selection information may include a plurality of selection sets each including a plurality of the selected options selected by the user from among the plurality of vehicle options, the delivery timing information may indicate a plurality of delivery timings, each of the delivery timings being determined for a corresponding one of the selection sets, and the method may further include outputting, by the controller, the delivery timings via the output unit.

The method according to the above aspect may further include outputting, by the controller, the delivery timings in order from an earliest delivery timing together with the selection sets via the output unit.

The method according to the above aspect may further include: receiving, by the controller from the information processing device via the communication unit, deletion candidate option information indicating a deletion candidate option that is expected to, when not selected, bring forward the delivery timing by a predetermined period or more among the one or more selected options indicated by the selection information; and outputting, by the controller, the deletion candidate option with highlight via the output unit.

In the method according to the above aspect, the delivery timing information may include a delivery timing in a case where the deletion candidate option is replaced with another option among the at least one of the vehicle options indicated by the option information, and the method may further include outputting, by the controller via the output unit, an updated delivery timing, the updated delivery timing being the delivery timing updated in the case where the deletion candidate option is replaced with the other option.

In the method according to the above aspect, the other option may include a vehicle option of which the number of times of selection by users other than the user is equal to or larger than a predetermined value.

The method according to the above aspect may further include: receiving, by the controller from the information processing device via the communication unit, information indicating a period that affects determination of the at least one delivery timing and is associated with the one or more selected options indicated by the selection information; and outputting, by the controller, the period via the output unit.

The method according to the above aspect may further include: receiving, by the controller from the information processing device via the communication unit, estimate information indicating an estimated price in a case where the one or more selected options indicated by the selection information are selected; and outputting, by the controller, the estimated price via the output unit.

A terminal device according to a third aspect of the present disclosure is a terminal device including an input unit, an output unit, a communication unit configured to communicate with an information processing device configured to provide a sales website for vehicle options, and a controller. The controller is configured to: receive option information indicating at least one of the vehicle options from the information processing device via the communication unit; output the at least one of the vehicle options via the output unit; receive an input of one or more selected options selected by a user from the at least one of the vehicle options via the input unit; transmit selection information indicating the one or more selected options to the information processing device via the communication unit; receive, from the information processing device via the communication unit, delivery timing information indicating at least one delivery timing determined based on the one or more selected options indicated by the selection information; and output the at least one delivery timing together with the one or more selected options via the output unit.

In the terminal device according to the above aspect, the at least one of the vehicle options indicated by the option information may be a plurality of vehicle options, the selection information may include a plurality of selection sets each including a plurality of the selected options selected by the user from among the plurality of vehicle options, the delivery timing information may indicate a plurality of delivery timings, each of the delivery timings being determined for a corresponding one of the selection sets, and the controller may be configured to output the delivery timings via the output unit.

In the terminal device according to the above aspect, the controller may be configured to output the delivery timings in order from an earliest delivery timing together with the selection sets via the output unit.

In the terminal device according to the above aspect, the controller may be configured to: receive, from the information processing device via the communication unit, deletion candidate option information indicating a deletion candidate option that is expected to, when not selected, bring forward the delivery timing by a predetermined period or more among the one or more selected options indicated by the selection information; and output the deletion candidate option with highlight via the output unit.

In the terminal device according to the above aspect, the delivery timing information may include a delivery timing in a case where the deletion candidate option is replaced with another option among the at least one of the vehicle options indicated by the option information, and the controller may be configured to output, via the output unit, an updated delivery timing, the updated delivery timing being the delivery timing updated in the case where the deletion candidate option is replaced with the other option.

In the terminal device according to the above aspect, the other option may include a vehicle option of which the number of times of selection by users other than the user is equal to or larger than a predetermined value.

In the terminal device according to the above aspect, the controller may be configured to: receive, from the information processing device via the communication unit, information indicating a period that affects determination of the at least one delivery timing and is associated with the one or more selected options indicated by the selection information; and output the period via the output unit.

In the terminal device according to the above aspect, the controller may be configured to: receive, from the information processing device via the communication unit, estimate information indicating an estimated price in a case where the one or more selected options indicated by the selection information are selected; and output the estimated price via the output unit.

According to the present disclosure, it is possible to improve the technology that assists users when purchasing vehicle options.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2A is a flowchart showing an operation of the system according to the embodiment of the present disclosure;

FIG. 2B is a flowchart showing the operation of the system according to the embodiment of the present disclosure;

FIG. 2C is a flowchart showing the operation of the system according to the embodiment of the present disclosure;

FIG. 3 is a diagram illustrating options indicated by selection information, a deletion candidate option, delivery timings, and an updated delivery timing that are output to a terminal device; and

FIG. 4 is a diagram illustrating the options indicated by the selection information, the deletion candidate option, the delivery timings, the updated delivery timing, and periods that affect determination of the delivery timings that are output to the terminal device.

### DETAILED DESCRIPTION OF EMBODIMENTS

Hereinafter, an embodiment of the present disclosure will be described below with reference to the drawings. In each drawing, the same or corresponding parts are denoted by the same reference signs. In the present embodiment, description of the same or corresponding parts will be omitted or simplified as appropriate.

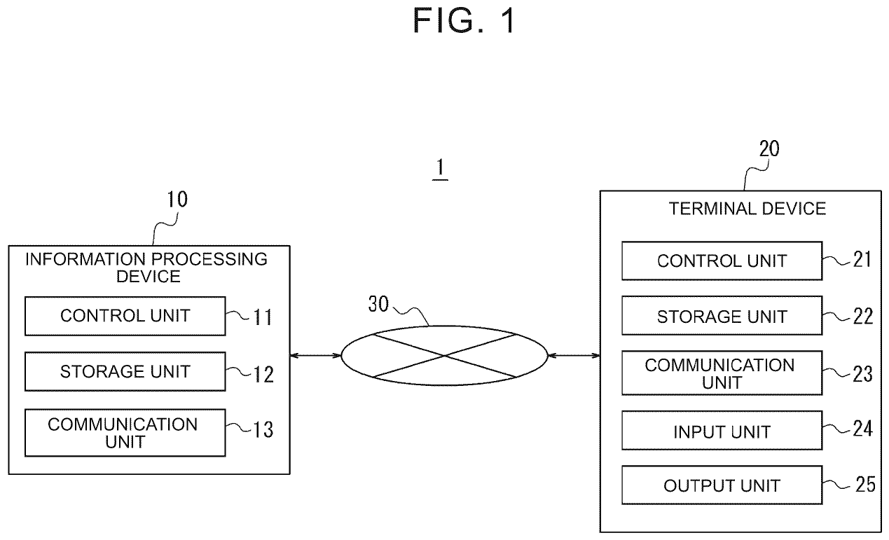

The configuration of a system 1 according to the present embodiment will be described with reference to FIG. 1. The system 1 includes an information processing device 10 and a terminal device 20. The information processing device 10 is configured to communicate with the terminal device 20 via a network 30.

The information processing device 10 is a computer installed in a facility such as a data center. The information processing device 10 is operated by a business operator that sells vehicle options. The information processing device 10 provides a sales website for vehicles and vehicle options.

The terminal device 20 is carried by a user. The terminal device 20 is a mobile device such as a mobile phone, a smartphone, or a tablet, or a PC. The term “PC” is an abbreviation for “personal computer”.

The network 30 includes the Internet, at least one WAN, at least one MAN, or any combination thereof. The term “WAN” is an abbreviation for “wide area network”. The term “MAN” is an abbreviation for “metropolitan area network”. The network 30 may include at least one wireless network, at least one optical network, or any combination thereof. Examples of the wireless network include an ad hoc network, a cellular network, a wireless LAN, a satellite communication network, or a terrestrial microwave network. The term “LAN” is an abbreviation for “local area network”.

An overview of the present embodiment will be given first, and details of the present embodiment will be given later. The terminal device 20 receives option information indicating at least one option (vehicle option) from the information processing device 10. The terminal device 20 outputs at least one option and receives an input of one or more options (selected option) selected by a user from the at least one option. The terminal device 20 transmits selection information indicating the one or more options to the information processing device 10. The terminal device 20 receives, from the information processing device 10, delivery timing information indicating at least one delivery timing determined based on the one or more options indicated by the selection information. The terminal device 20 outputs the at least one delivery timing together with the one or more options. In one embodiment, wireless transmission and reception are performed between the terminal device 20 and the information processing device 10 via the network 30.

Vehicle options can be selected and purchased by the user at the time of purchasing the vehicle. The vehicle options are options that can be selected by the user in place of or in addition to the standard equipment of the vehicle to be purchased. Specifically, the options include any kinds of vehicle body color, seat material and color, seat heater, navigation device, door mirror, rearview monitor, air purifier, etc. According to the present embodiment, the vehicle delivery timing is displayed on the terminal device 20 together with the options selected by the user. Therefore, the user can know the effect of the option selection on the delivery timing. The user can use the delivery timing for consideration about the purchase of the vehicle, thereby improving user convenience. Thus, it is possible to improve the technology that assists the user in selecting the options.

The configuration of the information processing device 10 according to the present embodiment will be described with reference to FIG. 1. The information processing device 10 includes a control unit 11, a storage unit 12, and a communication unit 13.

The control unit 11 includes at least one processor, at least one programmable circuit, at least one dedicated circuit, or any combination thereof. The processor is a general-purpose processor such as a CPU or a GPU, or a processor dedicated to specific processes. The term “CPU” is an abbreviation for “central processing unit”. The term “GPU” is an abbreviation for “graphics processing unit”. Examples of the programmable circuit include an FPGA. The term “FPGA” is an abbreviation for “field-programmable gate array”. Examples of the dedicated circuit include an ASIC. The term “ASIC” is an abbreviation for “application specific integrated circuit”. The control unit 11 executes a process related to operation of the information processing device 10 while controlling the various units of the information processing device 10.

The storage unit 12 includes at least one semiconductor memory, at least one magnetic memory, at least one optical memory, or any combination thereof. Examples of the semiconductor memory include a RAM, a ROM, and a flash memory. The term “RAM” is an abbreviation for “random access memory”. The term “ROM” is an abbreviation for “read only memory”. Examples of the RAM include an SRAM and a DRAM. The term “SRAM” is an abbreviation for “static random access memory”. The term “DRAM” is an abbreviation for “dynamic random access memory”. Examples of the ROM include an EEPROM. The term “EEPROM” is an abbreviation for “electrically erasable programmable read only memory”. Examples of the flash memory include an SSD. The term “SSD” is an abbreviation for “solid-state drive”. Examples of the magnetic memory include an HDD. The term “HDD” is an abbreviation for “hard disk drive”. The storage unit 12 functions as, for example, a main storage device, an auxiliary storage device, or a cache memory. The storage unit 12 stores information to be used for the operation of the information processing device 10 and information obtained by the operation of the information processing device 10.

The communication unit 13 includes at least one communication module. The communication module is, for example, a module compatible with a wired LAN communication standard such as Ethernet (registered trademark) or a wireless LAN communication standard such as IEEE 802.11. The term “IEEE” is an abbreviation for “Institute of Electrical and Electronics Engineers”. The communication unit 13 communicates with devices other than the information processing device 10. The communication unit 13 receives the information to be used for the operation of the information processing device 10, and transmits the information obtained by the operation of the information processing device 10.

The configuration of the terminal device 20 according to the present embodiment will be described with reference to FIG. 1. The terminal device 20 includes a control unit (controller) 21, a storage unit 22, a communication unit 23, an input unit 24, and an output unit 25. The hardware configurations of the control unit 21, the storage unit 22, and the communication unit 23 of the terminal device 20 may be similar to the hardware configurations of the control unit 11, the storage unit 12, and the communication unit 13 of the information processing device 10, respectively. The description will be omitted herein.

The input unit 24 includes at least one input interface. Examples of the input interface include a physical key, a capacitive key, a pointing device, a touch screen integrated with a display, and a microphone. The input unit 24 receives an operation for inputting data to be used for the operation of the terminal device 20. The input unit 24 may be connected to the terminal device 20 as an external input device instead of being provided in the terminal device 20. Any method such as USB, HDMI (registered trademark), or Bluetooth (registered trademark) can be used as a connection method. The term “USB” is an abbreviation for “universal serial bus”. The term “HDMI (registered trademark)” is an abbreviation for “high-definition multimedia interface”.

The output unit 25 includes at least one output interface. Examples of the output interface include a display and a loudspeaker. Examples of the display include an LCD and an organic EL display. The term “LCD” is an abbreviation for “liquid crystal display”. The term “EL” is an abbreviation for “electroluminescence”. The output unit 25 outputs data obtained by the operation of the terminal device 20. The output unit 25 may be connected to the terminal device 20 as an external output device instead of being provided in the terminal device 20. Any method such as USB, HDMI (registered trademark), or Bluetooth (registered trademark) can be used as a connection method.

The functions of the information processing device 10 or the terminal device 20 are implemented by executing a program according to the present embodiment on a processor serving as the control unit 11 or the control unit 21. That is, the functions of the information processing device 10 or the terminal device 20 are implemented by software. The program causes a computer to execute the operation of the information processing device 10 or the terminal device 20, thereby causing the computer to function as the information processing device 10 or the terminal device 20. That is, the computer functions as the information processing device 10 or the terminal device 20 by executing the operation of the information processing device 10 or the terminal device 20 in accordance with the program.

The program can be stored in a non-transitory computer-readable medium. Examples of the non-transitory computer-readable medium include a flash memory, a magnetic recording device, an optical disc, a magneto-optical recording medium, and a ROM. For example, the program is distributed by selling, transferring, or renting a portable medium storing the program, such as an SD card, a DVD, or a CD-ROM. The term “SD” is an abbreviation for “secure digital”. The term “DVD” is an abbreviation for “digital versatile disc”. The term “CD-ROM” is an abbreviation for “compact disc read only memory”. The program may be distributed by storing the program in a storage of a server and transferring the program from the server to other computers. The program may be provided as a program product.

For example, the computer temporarily stores the program stored in the portable medium or the program transferred from the server in the main storage device. The computer then causes the processor to read the program stored in the main storage device, and causes the processor to execute processes in accordance with the read program. The computer may read the program directly from the portable medium and execute the processes in accordance with the program. The computer may execute the processes in accordance with the received program every time the program is transferred from the server to the computer. The processes may be executed by a so-called ASP service in which the functions are implemented only by execution instructions and result acquisition without transferring the program from the server to the computer. The term “ASP” is an abbreviation for “application service provider”. The program includes information that is provided for processing by an electronic computer and equivalent to the program. For example, data that is not a direct command to the computer but has the property of defining the processing of the computer is the “information equivalent to the program”.

Part or all of the functions of the information processing device 10 or the terminal device 20 may be implemented by a programmable circuit or a dedicated circuit serving as the control unit 11 or the control unit 21. That is, part or all of the functions of the information processing device 10 or the terminal device 20 may be implemented by hardware.

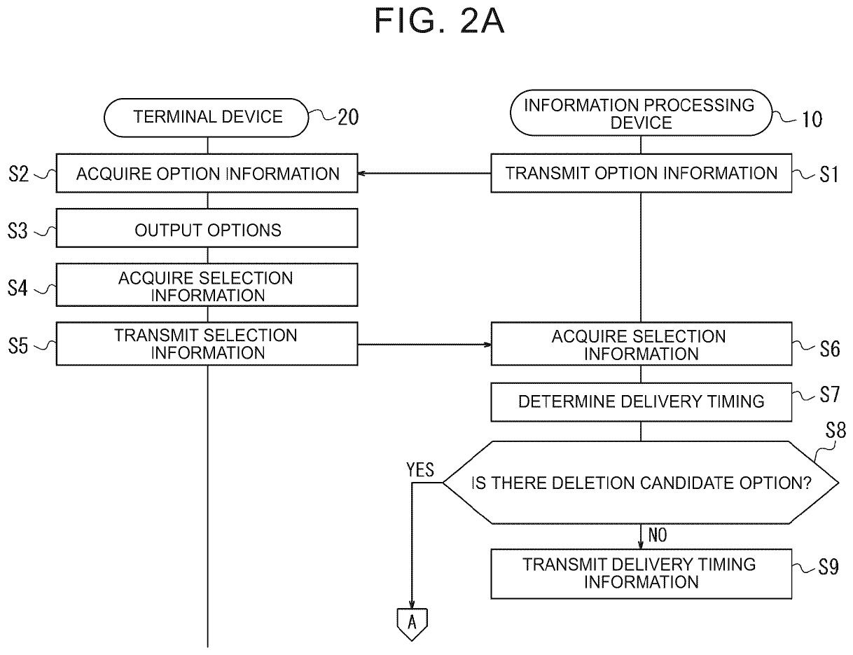

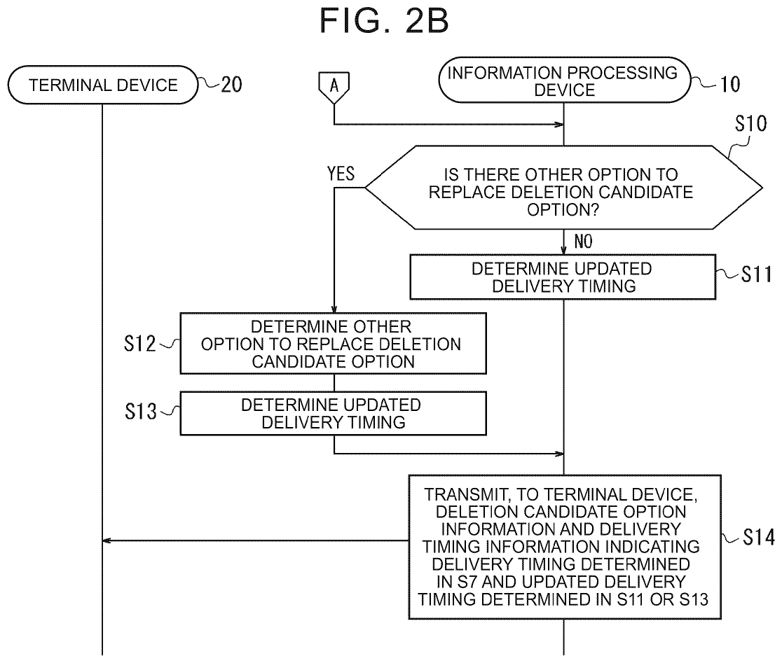

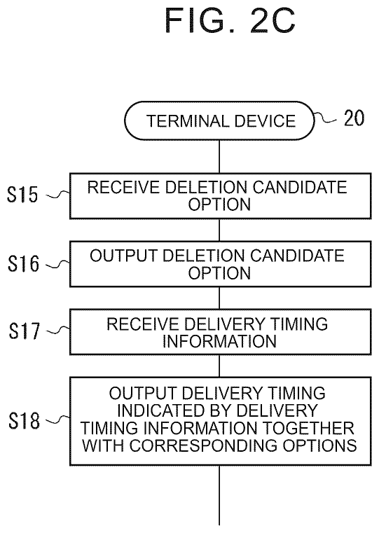

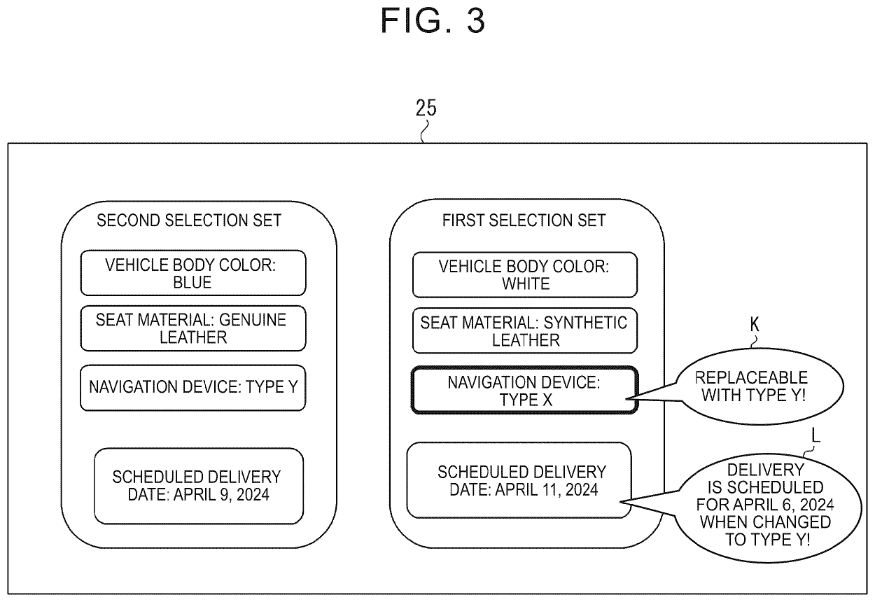

The operations of the system 1 according to the present embodiment will be described with reference to FIGS. 2A to 3. Among the operations shown in FIGS. 2A to 2C, the operation of the terminal device 20 corresponds to the method according to the present embodiment. In the following description, it is assumed that communication between the information processing device 10 and an external device is performed via the communication unit 13 and the network 30 and communication between the terminal device 20 and an external device is performed via the communication unit 23 and the network 30. In this example, it is assumed that the information processing device 10 has acquired information indicating a vehicle for sale to be purchased by a user.

In S1 of FIG. 2A, the control unit 11 of the information processing device 10 transmits option information indicating at least one option to the terminal device 20. In this example, the at least one option is a plurality of options.

In S2, the control unit 21 of the terminal device 20 receives and acquires the option information.

In S3, the control unit 21 outputs the at least one option indicated by the option information via the output unit 25.

In S4, the control unit 21 receives, via the input unit 24, an input of one or more options selected by the user from the at least one option output in S3, and generates selection information indicating the one or more options. In this manner, the control unit 21 acquires the selection information. The control unit 21 may receive, via the input unit 24, an input of at least one selection set including a plurality of options selected by the user, and generate the selection information. The at least one selection set may be a plurality of selection sets. In this example, it is assumed that the user inputs, via the input unit 24, a first selection set including a plurality of options, namely, a vehicle body color “white”, a kind of seat “synthetic leather”, and a navigation device “type X”, and a second selection set including a plurality of options, namely, a vehicle body color “blue”, a kind of seat “genuine leather”, and a navigation device “type Y”. The control unit 21 receives the input and acquires it as selection information including the first selection set and the second selection set.

In S5, the control unit 21 transmits the selection information indicating the one or more options to the information processing device 10.

In S6, the control unit 11 of the information processing device 10 receives and acquires the selection information.

In S7, the control unit 11 determines the delivery timing based on the options indicated by the selection information. Any method may be used to determine the delivery timing. For example, the control unit 11 refers to information indicating the number of days that is a period added to the standard delivery date serving as the standard delivery timing when each option indicated by the selection information is selected, and determines an option with the largest number of days among the options indicated by the selection information as a target option. The information may be preset and stored in the storage unit 12. Information indicating the standard delivery date may be prestored in the storage unit 12 in association with the vehicle for sale. The control unit 11 determines a date calculated by adding the number of days related to the determined target option to the standard delivery date as a delivery date serving as the delivery timing. The delivery timing is not limited to a date, but may be indicated by a month or by “beginning”, “middle”, or “end” of a month. The delivery timing may be indicated by time.

For example, it is assumed that the options indicated by the selection information are a vehicle body color “red”, a seat material “genuine leather”, and a navigation device “type X”. It is assumed that the numbers of days added to the standard delivery date for the options are two days for the vehicle body color “red”, eight days for the seat material “genuine leather”, and 10 days for the navigation device “type X”, and the standard delivery date is Apr. 1, 2024. The control unit 11 determines the navigation device “type X” as the target option, and determines, as the delivery date, Apr. 11, 2024 calculated by adding 10 days to the standard delivery date.

The method for determining the delivery date is not limited to this. The control unit 11 may determine the delivery date by referring to information indicating the numbers of days as the periods associated with the options, simply adding these numbers of days together, and adding the resultant number of days to the delivery date. The information may be prestored in the storage unit 12. For example, it is assumed that the options indicated by the selection information are a vehicle body color “green” and a sunroof “type Q”. It is assumed that the numbers of days associated with the options are one day for the vehicle body color “green” and 10 days for the sunroof “type Q”, and the standard delivery date is Apr. 1, 2024. The control unit 11 may add 11 days calculated by adding one day and 10 days together to the standard delivery date, and determine Apr. 12, 2024 as the delivery date.

When the selection information includes a plurality of selection sets, the control unit 11 may determine the delivery timing for each selection set. In this example, it is assumed that, for the options in the first selection set indicated by the selection information, namely, the vehicle body color “white”, the seat material “synthetic leather”, and the navigation device “type X”, the numbers of days added to the standard delivery date are five days for the vehicle body color “white”, four days for the seat material “synthetic leather”, and 10 days for the navigation device “type X”. It is assumed that the standard delivery date is Apr. 1, 2024. The control unit 11 determines the navigation device “type X” as the target option, and determines, as the delivery date of the first selection set, Apr. 11, 2024 calculated by adding 10 days to the standard delivery date. It is assumed that, for the options in the second selection set indicated by the selection information, namely, the vehicle body color “blue”, the seat material “genuine leather”, and the navigation device “type Y”, the numbers of days added to the standard delivery date are three days for the vehicle body color “blue”, eight days for the seat material “genuine leather”, and zero days for the navigation device “type Y”, and the standard delivery date is Apr. 1, 2024. The control unit 11 determines the seat material “genuine leather” as the target option, and determines, as the delivery date of the second selection set, Apr. 9, 2024 calculated by adding eight days to the standard delivery date.

In S8, the control unit 21 determines whether there is a deletion candidate option that would bring forward the delivery timing by a predetermined period or more if not selected. In this example, when the number of days related to the target option determined in S7 is equal to or larger than a predetermined value, the control unit 11 determines that there is a deletion candidate option, and proceeds to S10. When the number of days related to the target option determined in S7 is smaller than the predetermined value, the control unit 11 determines that there is no deletion candidate option, and proceeds to S9. The predetermined value may be preset and stored in the storage unit 12.

In this example, the predetermined value is 10 days. Among the options in the first selection set, the number of days added to the standard delivery date for the target option, namely, the navigation device “type X” is 10 days. Since the number of days is equal to or larger than the predetermined value of 10 days, the control unit 11 determines that there is a deletion candidate option in the first selection set. Among the options in the second selection set, the number of days added to the standard delivery date for the target option, namely, the seat material “genuine leather” is eight days. Since the number of days is smaller than the predetermined value of 10 days, the control unit 11 determines that there is no deletion candidate option in the second selection set. The process of the control unit 11 proceeds to S10 for the first selection set, and to S9 for the second selection set. The control unit 11 may repeat the processes from S8 to S14 for all selection sets in the selection information.

Description will be given of a case where the control unit 11 determines in S8 that there is no deletion candidate option and the process of the control unit 11 proceeds to S9. In S9, the control unit 11 transmits, to the terminal device 20, delivery timing information indicating the delivery timing determined in S7. Then, the operation of the system 1 proceeds to S17.

In S10 of FIG. 2B, the control unit 11 determines whether there is another option that can replace the deletion candidate option. For example, the control unit 11 determines that there is another option when the options indicated by the option information include an option of the same kind as that of the deletion candidate option with a smaller number of days than that of the deletion candidate option as the period added to the standard delivery date serving as the standard delivery timing. When there is no option with a smaller number of days added to the standard delivery date than that of the deletion candidate option, the control unit 11 determines that there is no other option. When determination is made that there is no other option, the process of the control unit 11 proceeds to S11. When determination is made that there is another option, the process of the control unit 11 proceeds to S12.

In this example, there is an option of the navigation device “type Y”, which is the same kind as that of the navigation device “type X” that is the deletion candidate option in the first selection set with a smaller number of days added to the standard delivery date than that of the deletion candidate option. Therefore, the control unit 11 determines that there is another option, and the process of the control unit 11 proceeds to S12.

Description will be given of a case where the control unit 11 determines in S10 that there is no other option and the process of the control unit 11 proceeds to S11. In S11, the control unit 11 determines, as an updated delivery timing, a delivery date that is a delivery timing in the case where the deletion candidate option is deleted. In this case, the control unit 11 deletes the deletion candidate option in the selection set, and determines, among the remaining options in the selection set, a target option with the largest number of days that is the period added to the standard delivery date serving as the standard delivery timing. The control unit 11 determines a date calculated by adding the number of days related to the determined target option to the standard delivery date as an updated delivery date serving as the updated delivery timing.

Next, description will be given of a case where the control unit 11 determines in S10 that there is another option and the process of the control unit 11 proceeds to S12. In S12, the control unit 11 determines another option to replace the deletion candidate option.

Any method may be used to determine the other option. For example, when there is a plurality of options of the same kind as that of the deletion candidate option with smaller numbers of days added to the standard delivery date than that of the deletion candidate option, the control unit 11 may determine an option with the smallest number of days as the other option. In this example, the control unit 11 determines the navigation device “type Y” as the other option.

For example, the control unit 11 may determine, as the other option, an option that is of the same kind as that of the deletion candidate option and that has been selected by users other than the user a number of times that is equal to or larger than a predetermined value. The predetermined value may be prestored in the storage unit 12. The control unit 11 may determine the other option by referring to information stored in the storage unit 12 and indicating an option purchase history of other users. For example, it is assumed that the numbers of days added to the standard delivery date for the navigation device “type Y” and a navigation device “type Z” are smaller than that for the deletion candidate option “type X”. It is assumed that, of the navigation devices “type Y” and “type Z”, the number of times “type Z” has been selected by other users is equal to or larger than the predetermined value. In this case, the control unit 11 determines “type Z” as the option to replace the deletion candidate option “type X”. Thus, a popular option selected by other users serves as a replacement as the other option, thereby improving the possibility that the user will accept and purchase the other option.

In S13, the control unit 11 determines, as an updated delivery date serving as the updated delivery timing, a delivery date serving as the delivery timing in the case where the deletion candidate option is replaced with the other option determined in S12. In this example, the control unit 11 replaces the navigation device “type X” in the first selection set with the other option, namely, the navigation device “type Y”, and determines, in the first selection set, a target option with the largest number of days added to the standard delivery date. In this example, the numbers of days added to the standard delivery date are five days for the vehicle body color “white”, four days for the seat material “synthetic leather”, and zero days for the navigation device “type Y”. The control unit 11 determines the option of the vehicle body color “white” as the target option as in S7, and determines Apr. 6, 2024 calculated by adding five days to the standard delivery date of Apr. 1, 2024 as the updated delivery date.

In S14, the control unit 11 transmits, to the terminal device 20, deletion candidate option information indicating the deletion candidate option, and delivery timing information indicating the delivery timing determined in S7 and the updated delivery timing determined in S11 or S13. The control unit 11 may include the other option to replace the deletion candidate option in the deletion candidate option information and transmit the deletion candidate option information to the terminal device 20. In this example, the control unit 11 transmits, to the terminal device 20, deletion candidate option information indicating the deletion candidate option “type X” and the other option “type Y” serving as a replacement, and delivery timing information indicating the delivery date of Apr. 11, 2024 determined in S7 for the first selection set and the updated delivery date of Apr. 6, 2024 determined in S13.

In S15 of FIG. 2C, the control unit 21 of the terminal device 20 receives the deletion candidate option from the information processing device 10.

In S16, the control unit 21 outputs the deletion candidate option information indicating the deletion candidate option via the output unit 25. When the deletion candidate option information further includes the other option determined in S12, the control unit 21 may further output the other option with highlight.

In S17, the control unit 21 receives the delivery timing information from the information processing device 10.

In S18, the control unit 21 outputs the delivery timing indicated by the delivery timing information via the output unit 25 together with one or more options. When the delivery timing information also includes the updated delivery timing determined in S11 or S13, the control unit 21 may output the updated delivery timing via the output unit 25 as well.

The control unit 21 may arrange the selection sets indicated by the selection information in order from the earliest delivery timing or the earliest updated delivery timing, and output the arranged selection sets via the output unit 25. Thus, the user can easily and immediately grasp, among the selected selection sets, the selection set that is a combination of options with an early delivery timing.

FIG. 3 is a diagram showing the output unit 25 that outputs the first selection set, the second selection set, the deletion candidate option, delivery dates serving as the delivery timings, and the updated delivery date serving as the updated delivery timing. In FIG. 3, the selection sets are displayed in the order of the second selection set and the first selection set from the left, namely, in the order from the earliest delivery date. Referring to FIG. 3, the delivery date is Apr. 9, 2024 for the second selection set. For the first selection set, the delivery date is Apr. 11, 2024, and the navigation device “type X” that is the deletion candidate option is highlighted with a thick frame. That is, when determination is made that there is another option to replace the deletion candidate option, the output screen is changed to show the other option that replaces the deletion candidate option. The option of the navigation device “type Y” that is the other option serving as a replacement and the updated delivery date determined in S13 in the case where the option is changed to the option of the navigation device “type Y” are shown in balloons K and L, respectively. That is, when determination is made that there is another option serving as a replacement and the updated delivery date is determined, the output screen is changed to show the other option serving as a replacement and the updated delivery date.

In this manner, the control unit 21 outputs the delivery timing together with one or more options via the output unit 25. Then, the operations of the system end.

The present disclosure is not limited to the embodiment described above. For example, two or more blocks in the block diagram may be integrated, or a single block may be divided apart. Two or more steps in the flowchart may be executed in parallel or in different order as necessary or based on processing capacities of devices that execute the steps, instead of being executed in time series in accordance with description. Other modifications may be made without departing from the gist of the present disclosure.

For example, the control unit 11 of the information processing device 10 may transmit, to the terminal device 20, estimate information indicating an estimated price in a case where the option indicated by the selection information is purchased. In this case, the terminal device 20 may output the estimated price together with the delivery timing via the output unit 25. The estimate information may include an estimated price in a case where the other option to replace the deletion candidate option is included, and the control unit 21 may output the estimated price together with the updated delivery timing. Therefore, the user can easily use the estimated price for consideration about options as well as the delivery timing or the updated delivery timing. Thus, user convenience when purchasing options is improved.

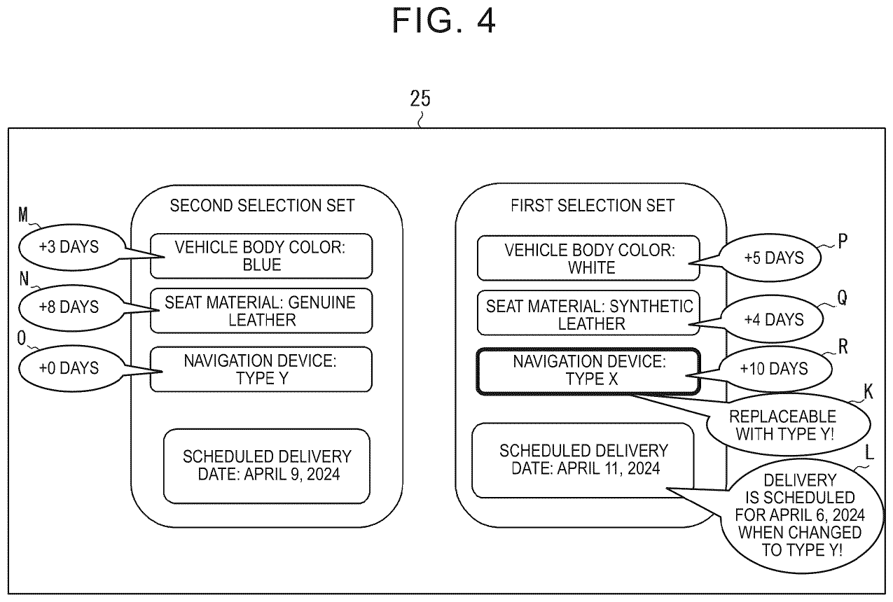

For example, the control unit 11 of the information processing device 10 may transmit, to the terminal device 20, information indicating a period that affects the determination of the delivery timing and is associated with one or more options indicated by the selection information. The period that affects the determination of the delivery timing includes the number of days added to the standard delivery date. Without being limited thereto, the period that affects the determination of the delivery timing may be the numbers of days that are associated with the options indicated by the selection information and are added together to calculate the number of days to be added to the delivery date. The control unit 21 of the terminal device 20 receives the information and outputs it via the output unit 25. FIG. 4 shows an example of the screen output by the terminal device 20 on the output unit 25 in the present modification. Referring to FIG. 4, the numbers of days added to the standard delivery date and associated with the options are further shown in balloons M to R in comparison with FIG. 3 of the above embodiment. Therefore, the user can grasp at a glance how much each option affects the delivery date. Thus, user convenience when purchasing options is improved.

Part of the embodiment of the present disclosure is shown as an example below. However, the embodiment of the present disclosure is not limited thereto.

### Appendix 1

A method to be executed by a terminal device including an input unit, an output unit, a communication unit configured to communicate with an information processing device configured to provide a sales website for vehicle options, and a control unit, the method including: receiving, by the control unit, option information indicating at least one option from the information processing device via the communication unit; outputting, by the control unit, the at least one option via the output unit; receiving, by the control unit, an input of one or more options selected by a user from the at least one option via the input unit; transmitting, by the control unit, selection information indicating the one or more options to the information processing device via the communication unit; receiving, by the control unit from the information processing device via the communication unit, delivery timing information indicating at least one delivery timing determined based on the one or more options indicated by the selection information; and outputting, by the control unit, the at least one delivery timing together with the one or more options via the output unit.

### Appendix 2

The method according to appendix 1, in which: the at least one option indicated by the option information is a plurality of options; the selection information includes a plurality of selection sets each including a plurality of options selected by the user from among the plurality of options; the delivery timing information indicates a plurality of delivery timings, each of the delivery timings being determined for a corresponding one of the selection sets; and the method further includes outputting, by the control unit, the delivery timings via the output unit.

### Appendix 3

The method according to appendix 2, further including outputting, by the control unit, the delivery timings in order from an earliest delivery timing together with the selection sets via the output unit.

### Appendix 4

The method according to any one of appendices 1 to 3, further including: receiving, by the control unit from the information processing device via the communication unit, deletion candidate option information indicating a deletion candidate option that is expected to, when not selected, bring forward the delivery timing by a predetermined period or more among the one or more options indicated by the selection information; and outputting, by the control unit, the deletion candidate option with highlight via the output unit.

### Appendix 5

The method according to appendix 4, in which: the delivery timing information includes a delivery timing in a case where the deletion candidate option is replaced with another option among the one or more options indicated by the option information; and the method further includes outputting, by the control unit via the output unit, an updated delivery timing in the case where the deletion candidate option is replaced with the other option.

### Appendix 6

The method according to appendix 5, in which the other option includes an option of which the number of times of selection by users other than the user is equal to or larger than a predetermined value.

### Appendix 7

The method according to any one of appendices 1 to 6, further including: receiving, by the control unit from the information processing device via the communication unit, information indicating a period that affects determination of the at least one delivery timing and is associated with the one or more options indicated by the selection information; and outputting, by the control unit, the period via the output unit.

### Appendix 8

The method according to any one of appendices 1 to 7, further including: receiving, by the control unit from the information processing device via the communication unit, estimate information indicating an estimated price in a case where the option indicated by the selection information is selected; and outputting, by the control unit, the estimated price via the output unit.

### Appendix 9

A terminal device including an input unit, an output unit, a communication unit configured to communicate with an information processing device configured to provide a sales website for vehicle options, and a control unit, in which the control unit is configured to: receive option information indicating at least one option from the information processing device via the communication unit; output the at least one option via the output unit; receive an input of one or more options selected by a user from the at least one option via the input unit; transmit selection information indicating the one or more options to the information processing device via the communication unit; receive, from the information processing device via the communication unit, delivery timing information indicating at least one delivery timing determined based on the one or more options indicated by the selection information; and output the at least one delivery timing together with the one or more options via the output unit.

### Appendix 10

The terminal device according to appendix 9, in which: the at least one option indicated by the option information is a plurality of options; the selection information includes a plurality of selection sets each including a plurality of options selected by the user from among the plurality of options; the delivery timing information indicates a plurality of delivery timings, each of the delivery timings being determined for a corresponding one of the selection sets; and the control unit is configured to output the delivery timings via the output unit.

### Appendix 11

The terminal device according to appendix 10, in which the control unit is configured to output the delivery timings in order from an earliest delivery timing together with the selection sets via the output unit.

### Appendix 12

The terminal device according to any one of appendices 9 to 11, in which the control unit is configured to: receive, from the information processing device via the communication unit, deletion candidate option information indicating a deletion candidate option that is expected to, when not selected, bring forward the delivery timing by a predetermined period or more among the one or more options indicated by the selection information; and output the deletion candidate option with highlight via the output unit.

### Appendix 13

The terminal device according to appendix 12, in which: the delivery timing information includes a delivery timing in a case where the deletion candidate option is replaced with another option among the one or more options indicated by the option information; and the control unit is configured to output, via the output unit, an updated delivery timing in the case where the deletion candidate option is replaced with the other option.

### Appendix 14

The terminal device according to appendix 13, in which the other option includes an option of which the number of times of selection by users other than the user is equal to or larger than a predetermined value.

### Appendix 15

The terminal device according to any one of appendices 9 to 14, in which the control unit is configured to: receive, from the information processing device via the communication unit, information indicating a period that affects determination of the at least one delivery timing and is associated with the one or more options indicated by the selection information; and output the period via the output unit.

### Appendix 16

The terminal device according to any one of appendices 9 to 15, in which the control unit is configured to: receive, from the information processing device via the communication unit, estimate information indicating an estimated price in a case where the option indicated by the selection information is selected; and output the estimated price via the output unit.

### Appendix 17

A program that causes a computer serving as a terminal device to execute operations, the terminal device including an input unit, an output unit, a communication unit configured to communicate with an information processing device configured to provide a sales website for vehicle options, and a control unit, the operations including: receiving option information indicating at least one option from the information processing device via the communication unit; outputting the at least one option via the output unit; receiving an input of one or more options selected by a user from the at least one option via the input unit; transmitting selection information indicating the one or more options to the information processing device via the communication unit; receiving, from the information processing device via the communication unit, delivery timing information indicating at least one delivery timing determined based on the one or more options indicated by the selection information; and outputting the at least one delivery timing together with the one or more options via the output unit.

### Appendix 18

The program according to appendix 17, in which: the at least one option indicated by the option information is a plurality of options; the selection information includes a plurality of selection sets each including a plurality of options selected by the user from among the plurality of options; the delivery timing information indicates a plurality of delivery timings, each of the delivery timings being determined for a corresponding one of the selection sets; and the operations further include outputting the delivery timings via the output unit.

### Appendix 19

The program according to appendix 18, in which the operations further include outputting the delivery timings in order from an earliest delivery timing together with the selection sets via the output unit.

### Appendix 20

The program according to any one of appendices 17 to 19, in which the operations further include: receiving, from the information processing device via the communication unit, deletion candidate option information indicating a deletion candidate option that is expected to, when not selected, bring forward the delivery timing by a predetermined period or more among the one or more options indicated by the selection information; and outputting the deletion candidate option with highlight via the output unit.

What is claimed is:

1. A method to be executed by a terminal device including an input unit, an output unit, a communication unit, and a controller, the communication unit being configured to communicate with an information processing device configured to provide information on vehicle options, the method comprising:
receiving, by the controller, option information from the information processing device via the communication unit, the option information indicating at least one of the vehicle options;
outputting, by the controller, the at least one of the vehicle options via the output unit;
receiving, by the controller, an input of one or more selected options selected by a user from the at least one of the vehicle options via the input unit;
transmitting, by the controller, selection information indicating the one or more selected options to the information processing device via the communication unit;
receiving, by the controller from the information processing device via the communication unit, delivery timing information indicating at least one delivery timing determined based on the one or more selected options indicated by the selection information; and
outputting, by the controller, the at least one delivery timing together with the one or more selected options via the output unit.

2. The method according to claim 1, wherein:
the at least one of the vehicle options indicated by the option information is a plurality of vehicle options;
the selection information includes a plurality of selection sets each including a plurality of the selected options selected by the user from among the plurality of vehicle options;
the delivery timing information indicates a plurality of delivery timings, each of the delivery timings being determined for a corresponding one of the selection sets; and
the method further includes outputting, by the controller, the delivery timings via the output unit.

3. The method according to claim 2, further comprising outputting, by the controller, the delivery timings in order from an earliest delivery timing together with the selection sets via the output unit.

4. The method according to claim 1, further comprising:
receiving, by the controller from the information processing device via the communication unit, deletion candidate option information indicating a deletion candidate option that is expected to, when not selected, bring forward the delivery timing by a predetermined period or more among the one or more selected options indicated by the selection information; and
outputting, by the controller, the deletion candidate option with highlight via the output unit.

5. A method to be executed by a terminal device including an input unit, an output unit, a communication unit, and a controller, the communication unit being configured to communicate with an information processing device configured to provide a sales website for vehicle options, the method comprising:
receiving, by the controller, option information from the information processing device via the communication unit, the option information indicating at least one of the vehicle options;
outputting, by the controller, the at least one of the vehicle options via the output unit;
receiving, by the controller, an input of one or more selected options selected by a user from the at least one of the vehicle options via the input unit;
transmitting, by the controller, selection information indicating the one or more selected options to the information processing device via the communication unit;
receiving, by the controller from the information processing device via the communication unit, delivery timing information indicating at least one delivery timing determined based on the one or more selected options indicated by the selection information; and
outputting, by the controller, the at least one delivery timing together with the one or more selected options via the output unit.

6. The method according to claim 5, wherein:
the at least one of the vehicle options indicated by the option information is a plurality of vehicle options;
the selection information includes a plurality of selection sets each including a plurality of the selected options selected by the user from among the plurality of vehicle options;
the delivery timing information indicates a plurality of delivery timings, each of the delivery timings being determined for a corresponding one of the selection sets; and
the method further includes outputting, by the controller, the delivery timings via the output unit.

7. The method according to claim 6, further comprising outputting, by the controller, the delivery timings in order from an earliest delivery timing together with the selection sets via the output unit.

8. The method according to claim 5, further comprising:
receiving, by the controller from the information processing device via the communication unit, deletion candidate option information indicating a deletion candidate option that is expected to, when not selected, bring forward the delivery timing by a predetermined period or more among the one or more selected options indicated by the selection information; and
outputting, by the controller, the deletion candidate option with highlight via the output unit.

9. The method according to claim 8, wherein:
the delivery timing information includes a delivery timing in a case where the deletion candidate option is replaced with another option among the at least one of the vehicle options indicated by the option information; and
the method further includes outputting, by the controller via the output unit, an updated delivery timing, the updated delivery timing being the delivery timing updated in the case where the deletion candidate option is replaced with the other option.

10. The method according to claim 9, wherein the other option includes a vehicle option of which the number of times of selection by users other than the user is equal to or larger than a predetermined value.

11. The method according to claim 5, further comprising:
receiving, by the controller from the information processing device via the communication unit, information indicating a period that affects determination of the at least one delivery timing and is associated with the one or more selected options indicated by the selection information; and
outputting, by the controller, the period via the output unit.

12. The method according to claim 5, further comprising:
receiving, by the controller from the information processing device via the communication unit, estimate information indicating an estimated price in a case where the one or more selected options indicated by the selection information are selected; and
outputting, by the controller, the estimated price via the output unit.

13. A terminal device comprising an input unit, an output unit, a communication unit configured to communicate with an information processing device configured to provide a sales website for vehicle options, and a controller, wherein the controller is configured to:
receive option information indicating at least one of the vehicle options from the information processing device via the communication unit;
output the at least one of the vehicle options via the output unit;
receive an input of one or more selected options selected by a user from the at least one of the vehicle options via the input unit;
transmit selection information indicating the one or more selected options to the information processing device via the communication unit;
receive, from the information processing device via the communication unit, delivery timing information indicating at least one delivery timing determined based on the one or more selected options indicated by the selection information; and
output the at least one delivery timing together with the one or more selected options via the output unit.

14. The terminal device according to claim 13, wherein:
the at least one of the vehicle options indicated by the option information is a plurality of vehicle options;
the selection information includes a plurality of selection sets each including a plurality of the selected options selected by the user from among the plurality of vehicle options;
the delivery timing information indicates a plurality of delivery timings, each of the delivery timings being determined for a corresponding one of the selection sets; and
the controller is configured to output the delivery timings via the output unit.

15. The terminal device according to claim 14, wherein the controller is configured to output the delivery timings in order from an earliest delivery timing together with the selection sets via the output unit.

16. The terminal device according to claim 13, wherein the controller is configured to:
receive, from the information processing device via the communication unit, deletion candidate option information indicating a deletion candidate option that is expected to, when not selected, bring forward the delivery timing by a predetermined period or more among the one or more selected options indicated by the selection information; and
output the deletion candidate option with highlight via the output unit.

17. The terminal device according to claim 16, wherein:
the delivery timing information includes a delivery timing in a case where the deletion candidate option is replaced with another option among the at least one of the vehicle options indicated by the option information; and
the controller is configured to output, via the output unit, an updated delivery timing, the updated delivery timing being the delivery timing updated in the case where the deletion candidate option is replaced with the other option.

18. The terminal device according to claim 17, wherein the other option includes a vehicle option of which the number of times of selection by users other than the user is equal to or larger than a predetermined value.

19. The terminal device according to claim 13, wherein the controller is configured to:
receive, from the information processing device via the communication unit, information indicating a period that affects determination of the at least one delivery timing and is associated with the one or more selected options indicated by the selection information; and
output the period via the output unit.

20. The terminal device according to claim 13, wherein the controller is configured to:
receive, from the information processing device via the communication unit, estimate information indicating an estimated price in a case where the one or more selected options indicated by the selection information are selected; and
output the estimated price via the output unit.
